(19) United States
(12) Patent Application Publication
(10) Pub. No.: US 2012/0284787 A1
(43) Pub. Date: Nov. 8, 2012

(54) Personal Secured Access Devices

(76) Inventors: Olivier Clemot, Paris (FR); Gérard Bonningue, Charleville-Mezieres (FR)

(21) Appl. No.: 13/442,522

(22) Filed: Apr. 9, 2012

(30) Foreign Application Priority Data
Apr. 8, 2011 (FR) FR 1153101

(51) Int. Cl. G06F 21/00

(52) U.S. Cl. 726/7

(57) ABSTRACT

Secure access to a protected resource of a personal security device (PSD), using a user-associated PIN code, includes: providing a user-controlled local unit having an intermediate module for PIN entry, and authentication of the PSD by an escrow module. After positive PSD authentication, the intermediate module requests entry of the PIN, and the escrow module provides at least one secure session key (SSK) to the intermediate module. To generate an SSK the intermediate module sends the escrow module a single-use proof of knowledge of the PIN, where the proof is different from the PIN. If the proof is recognized, an SSK is generated by at least the escrow module based on secret information associated with the PSD. Each SSK is sent to the intermediate module, and a secured version of the PIN code is sent to the PSD via the intermediate module by means of each SSK.

This invention concerns the technical field of smart cards or personal security devices and, more particularly, the field of access to a protected resource of a smart card.

A smart card typically comprises one or more resources allowing the card holder or user to perform one or more transactions by means of this smart card. Among the operations that can be performed using a smart card, it is possible to mention payment transactions, signature operations, operations of identification and authentication, access to a protected place or site, or access to computer resources without this list being limited or exhaustive. To avoid these operations being able to be performed by a third party in possession of the smart card but would not be the user or the lawful owner, using it and/or gaining access to resources of the smart card is protected by an identifier code known only to the lawful owner and possibly to an entity that issued the card. A same identifier code can provide access to all protected resources of the smart card or only some of them. Thus, it possible that the smart card or the personal security device is associated with multiple PIN codes that allow each access to only part of the protected resources of the smart card or personal security device.

When the user wants to access or implement a protected resource of the smart card communicating with a local unit, the user enters the PIN code corresponding with that resource on a keypad of the local unit which transmits it directly to the smart card for verification. In case of positive verification the smart card allows access to the protected resource. The transmission of the PIN code is, in known systems, uncoded in such a ways as a malicious third party may be able to read the PIN code by “listening” or recording the communication of the local unit to the smart card.

This weakness of the system of implementing protected resources of the smart card is particularly troublesome when the smart card or the personal security device is used via a local unit consisting of a personal computer connected to a telecommunications network such that a wired or wireless local area network or wide area network such as the Internet. Such a personal computer generally does not offer guarantees of integrity to be certain that the PIN code will not be intercepted and therefore the identity of the owner of the smart card will be usurped in the event of theft of the smart card or the personal security device.

The need arose for a new system or method of access to protected resources of a smart card or a personal security device that offers guarantees of confidentiality and protection of the PIN code superior to those of the old systems.

To meet this objective, the invention concerns a method of access via a PIN code associated with a user to at least one protected resource of a personal security device communicating with a local unit controlled by the user. According to the invention, this access method comprises the following steps:
implementation by the local unit of an intermediate PIN code entry module,
authentication, via the intermediate module, of the personal security device by the escrow module,
in case of positive authentication of the personal security device by the escrow module:
   request, by the intermediate module, for the PIN code to be entered by the user,
   obtaining by the intermediate module from the escrow module of at least one secure session key, involving the following steps:
   sending by the intermediate module to the escrow module of proof of knowledge of the PIN code different from the PIN code and for single use,
   in case of recognition, by the escrow module, of the validity of the proof of knowledge of the PIN code, generation, at least by the escrow module, of at least one secure session key by means of secret information associated with the personal security device,
   sending of each secure session key to the intermediate module,
sending to the personal security device, by the intermediate module, of the PIN code in a secured form by means of each secure session key.

For the purposes of the invention, a personal security device (PSD) is a portable electronic device comprising hardware computing, storage, cryptography and communications resources tailored to intervene in such protocols of identification, authentication, electronic signature, encryption and access control without this list being limiting or exhaustive. As examples of personal security devices, it is possible to cite: smart cards, IC cards, mobile data storage devices, the subscriber identity module (SIM), Wireless Identity Module, USB keys, electronic identification tokens, secure application modules (SAM), hardware security modules (HSM), TPG chips of the Trusted Computing Group alliance and any personal electronic system comprising one or more of the aforementioned devices. Moreover, it can be stated that for the purposes of the invention, a smart card is an electronic device such as, for example, defined by the ISO 7816 standard with regard to contact smart cards and also the ISO 14443 standard with regard to contactless proximity smart cards. It can also refer to the book “Smart cards—theory and implementation” by Christian TAVERNIER—published by Dunod—second edition about the definitions and tools used for implementing smart cards.

For the purposes of the invention, an identifying code is called the PIN (personal identification number) code in English.

The authentication of the personal security device prior to entering the PIN code, ensures that the personal security device is present and authentic when the intermediate module sends the request for the PIN code to be entered. Thus, in the absence of an authentic card, the intermediate module does not issue the request for the PIN code to be entered and the escrow module will not verify proof of knowledge of the PIN code which might be presented without having previously authenticated the card through the same channel. The prior authentication of the personal security device protects against attacks on the PIN code by a third party pretending to be an intermediate module without having a authenticated personal security device.

For the purposes of the invention, the fact that authentication of the personal security device is done via the intermediate module means that the intermediate module is used as a relay or gateway for communications between the personal security device and escrow module. Thus, the escrow module is, during the implementation of the procedure according to the invention, in relation to the pair consisting of the personal security device and the intermediate module.

Furthermore, the implementation of the intermediate module for entering PIN code can confine “en clair” dissemination of the PIN code to only the intermediate module which is, preferably, adapted to capture entering the PIN code directly done by means of a man-machine interface of the local unit. Then, obtaining a secure session key from an escrow party makes it possible to transmit the PIN code device to the personal security device in a secured form, which ensures that if communications are listened to, between the personal security device and the local unit, by a malicious third party, it cannot easily access or cannot access the knowledge of the PIN code. Moreover, the generation of each session key by the escrow module avoids providing the tools needed to create secure session keys to users and revealing how to create secure session keys.

The invention therefore makes it possible to guarantee the origin of session keys. Thus in a process where access to the protected resource of the personal security device allows use of a service or transaction with a provider, the mere fact that the user could access or allow access to the protected resource is an indication for the provider that the user belongs to the set of users able to obtain a secure session key from the escrow party. It should be noted that the fact that each secure session key is generated using secret information associated with the personal security device ensures that only the personal security device can implement each secure session key, which impedes a man-in-the-middle attack. Furthermore, the implementation of secret information for the generation of secure session keys makes it possible to use robust security protocols such as secret key cryptographic algorithms, for example, such as DES and AES or public key algorithms, like RSA, used with session keys for single use.

Thus, when the invention is implemented:
no permanent confidential data, such as the secrets for generating secure session keys, is stored within the intermediate module, so that confidential data is protected against the risk of theft or corruption by an technical analysis of the intermediate module,
the value of the PIN code is never transmitted in an unprotected form outside the intermediate module, insofar as, on one hand, it is a proof of knowledge and not its direct value that is used, and, on the other hand, the session keys test whether an identifier is correct by submitting it in an encrypted form to the personal security device can be obtained from the module by an escrow party by an intermediate module other than the one having demonstrated simultaneously that it is directly connected to the personal security device and having knowledge of the PIN code via the provision of proof of knowledge. This combination provides the method, according to the invention, the advantage of having high resistance to external attacks.

For the purpose of increased security for the service provider, the implementation of an escrow module can also be used to perform authentication or identification of the user prior to delivering the secure session key. Thus, in one form of implementation of the invention, the method comprises an identification or authentication of the user by an escrow module and obtaining of each secure session key occurs only in case of positive authentication or identification of the user by the escrow module. The user may be identified by any suitable means such as using biometric data of the user. The user can also be identified using information from a document other than the personal security device, such as an identity card number for example. In this case, the identification of the user is enhanced with respect to the identification of the user resulting from the possession of the personal security device and knowledge of the PIN code that the user is normally alone to know.

According to the invention, the escrow module can be a module implemented at the level of the local unit either by being integrated in the latter or by communicating directly with it. The escrow module may, for example, be integrated in a security hardware module. According to the invention, the escrow module may instead be a remote module with which the intermediate module communicates via a telecommunications network. For the purposes of the invention, a telecommunications network is a local and/or extended network for medium or long distance communication between computer systems. A local and/or extended network operating according to TCP/IP protocol is an example of a telecommunications network within the meaning of the invention. In this context, the Internet is also an example of an extended network forming a telecommunications network within the meaning of the invention.

According to one characteristic of the invention designed to enhance security, exchanges between the intermediate module and the escrow module can be made by a secure link from the first exchanges even before the personal security device authentication and presentation of proof of knowledge of the PIN code. Among the protocols liable to be used for the establishment of such a secure link, it is possible to cite the TLS protocol for Transport Layer Security, formerly known as SSL (Secure Sockets Layer).

According to one variation of this characteristic, the secure link is established with an authentication of the escrow module by a certificate issued under a public key infrastructure. Such a public key infrastructure is also called PKI (Public Key Infrastructure).

According to one characteristic of the invention, the personal security device is authenticated through the mutual authentication of the personal security device and the escrow module. This characteristic enhances the characteristics of the authentication of the procedure according to the invention to the extent that there is, on the one hand, an authentication of the intermediate module by escrow module which among others allows an authentication and/or an identification of the couple local/user unit and, on the other hand, a secure personal authentication of the device by the escrow module which allows authentication in combination and/or identification of the local unit/user/personal security device set.

In one variation of this characteristic of the invention, the mutual authentication is done using a cryptographic challenge protocol of challenge-response type.

According to one implementation of the invention, the proof of knowledge is transmitted using a zero-knowledge type protocol. Such a protocol, referred to in English under the name “zero-knowledge protocol”, makes it possible, as its name suggests, to check mutual knowledge of information, usually a secret, by two separate systems without communicating the information itself. Thus, this form of implementation cancels the risk of allowing the PIN code to become known to a malicious third party who would have access to the information exchanged by the intermediate module and the escrow module.

According to one characteristic of this form of implementation, a secure connection between the intermediate module and the escrow module can be established, after entering the PIN code, according to an enhanced key exchange protocol authenticated by password in which the intermediate module is authenticated using an authentication element calculated from the PIN code, the escrow module having copy of the authentication element. Such a protocol is known as an Augmented Password Authenticated Key Exchange” (Augmented PAKE). Thus assuming that a malicious third party would have knowledge of the information held by the escrow module would manage to make the escrow module operate without having demonstrated a prior knowledge of the PIN code, the malicious party having access only to the authentication element, separate from the PIN code, cannot connect to the smart card to access the protected resource, if it has not discovered the PIN code itself. Indeed, in this form of implementation, even when the length of the PIN code is not enough to prevent brute force attacks, a malicious third party who manages to take the place of the escrow module and thus recovers the value of proof of possession of the PIN code could not, by a brute-force attack, find the value of the PIN code from the proof of possession.

In this form of implementation, the secure link obtained can be used to encrypt the session key sent to the intermediate module as the elements of this securing depend on the value of the PIN code, it ensures that in any scenario that the intermediate module is capable of receiving this value must already know the PIN code. This prohibits, for example, a malicious third party who succeeded in taking the man-in-the-middle position, in connection with the escrow module, to recover the session keys without knowledge of the PIN code and then use then to decrypt the message sent to the personal security device.

According to another characteristic of the invention, the escrow module may comprise a control module of the knowledge of the PIN code and a module for generating a secure session key. This dissociation of the two functions of the escrow module can increase security.

In a variation of this characteristic, the control module of the knowledge of the PIN code communicates with the module of secure session key generation via a secure mutual authentication connection.

Thus, it is conceivable that communications between the smart card and the escrow module and between the intermediate module and the escrow module would be managed only by the knowledge control module so that the information from the secure session key generation module pass by the knowledge control module. According to a variant of this characteristic, the intermediate module communicates only with the knowledge control module from the escrow module. Thus, access to secret information held by the secure session key generation module is made more difficult.

According to one characteristic of the invention designed to increase the security of the procedure, the escrow module can be at least partly integrated into a hardware security module (HSM).

According to a variation of this characteristic, the secure session key generation module and/or the knowledge control module is integrated in a hardware security module.

According to another characteristic of the invention also aimed at strengthening security, the knowledge control module and the session key generation module can each be installed on two separate servers.

According to yet another characteristic of the invention, the knowledge control module can be adapted to store sendings of proof of knowledge and to reject transactions based on a determined number of failures and/or security rules. Such a history record of the transaction and/or communications makes it possible to implement security rules to resist attacks, by brute force or dictionary among others.

According to a variant of this characteristic of the invention, the knowledge control module is associated with a fraud detection module adapted to store the PIN used each time proof of knowledge is sent and the result of knowledge control and to send an authorization of communication with the intermediate module to the knowledge control module in function of the PIN and the results of knowledge control.

Similarly, the escrow module can implement a countermeasure for making the response time of the escrow party independent of the proof of knowledge validity test result.

According to the invention, the PIN code intended for the intermediate module can be entered by any suitable means and among others by means of the local unit keypad. According to one implementation of the invention, the PIN code is entered through a GUI displaying a virtual keypad on a screen of the local unit and a pointing interface allowing the user to select characters on the virtual keypad. This characteristic of the invention is intended to limit risk of disclosure of the PIN code by “listening” to the information transmitted by a keypad and especially a wireless keypad.

For the purposes of the invention, a pointing interface is a hardware device for selecting an area or part of visual information or and image displayed by the GUI. Among the pointing interfaces, you can comprise the mouse, trackball or the like, trackpads, graphics or digitizing tablets or touch screens without this list being limiting or exhaustive.

The invention also relates to a computing device comprising means for communicating with a personal security device, man-machine interface means and communication with an escrow module, characterized in that the computing device comprises an intermediate module adapted to implement the procedure according to the invention.

The invention also relates to a computing device capable of forming a local unit comprising means for communication with a personal security device, man-machine interface means and means for communication with an escrow module, this computing device being adapted to implement the procedure, according to the invention, of access to a protected resource of a personal security device.

Of course, the different characteristics, variations and forms of implementing the access control procedure according to the invention, can be associated with each other in various combinations to the extent they are not incompatible or mutually exclusive.

Moreover, various other characteristics of the invention emerge from the description referred to in the appendix with drawings illustrating non-limiting forms of the procedure and the system, according to the invention, of access control to a protected resource of a personal security device.

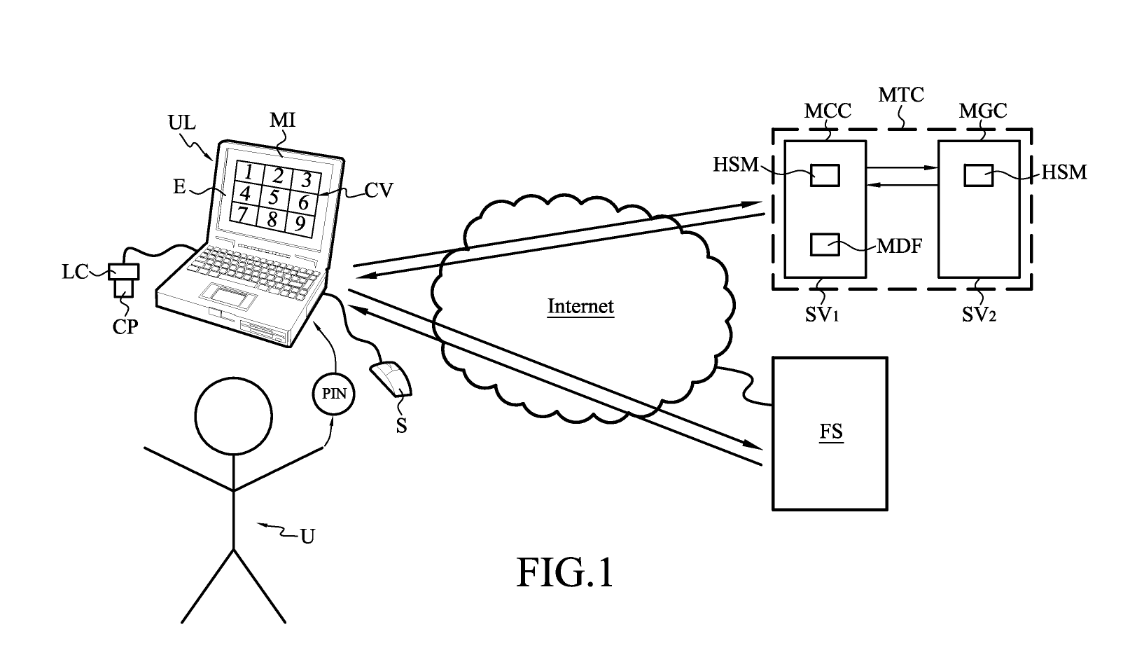

FIG. 1 is a schematic view of a system or an IT infrastructure for the implementation of the procedure according to the invention.

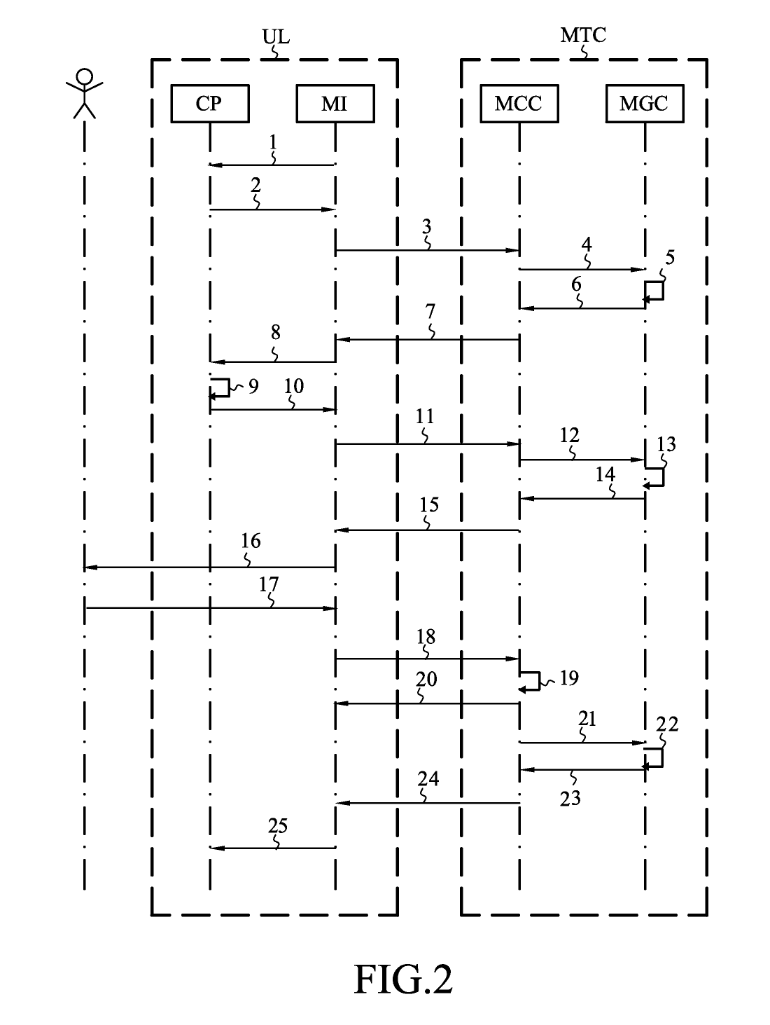

FIG. 2 is a schematic diagram of the various exchanges of information in a preferred form of implementation of the procedure according to the invention.

A system for the implementation of the invention comprises a local unit UL which comprises computing means as well as temporary and/or permanent data storage means in a way known in itself. The local unit UL also comprises means for man-machine interfaces allowing a user U to control the local unit UL. The man-machine interface means may for example comprise a keypad C, monitor E and mouse S. The local unit UL also comprises a communication interface with a telecommunications network such as a wired and/or Ethernet type radio interface for communication according to TCP/IP protocol on the Internet. The local unit may also comprise means of communication with a switched telecommunications network such as the telephone network. According to the invention, the local unit UL is adapted to communicate with a personal security device CP which in the framework of the described example is a smart card. Of course, the personal security device may be of another type. It should be noted that the terms “personal security device” and “smart card” are used interchangeably and are considered, unless otherwise indicated, as equivalent and interchangeable within the meaning of the invention.

The local unit also comprises means of communication LC with a personal security device CP such as a smart card reader for contact smart cards CP. Of course, the local unit UL may also comprise means of radio or optical communication with a contactless personal security device CP.

The local unit UL can for example be formed by a personal computer or through a payment terminal insofar as it comprises means of communication LC with a personal security device CP.

According to an example of a possible implementation of the invention, the user U who holds the personal security device CP wishes to use online services offered by a service provider FS, access to these services being monitored and requiring strong authentication using resources protected by the personal security device CP. To avoid misuse of the personal security device, the resource required for access to the provider's services is protected by a PIN code kept secret by the user U. To allow access or the implementation of the protected resource of the personal security device CP, it is necessary to send it the PIN code.

The invention proposes avoiding risks of “leaking” the PIN code within the local unit UL and its various connections, on one hand, to the personal security device CP, and on the other, to telecommunication networks by implementing, at the local unit, an intermediate module M1 intended among others to allow the entry of the PIN code and to ensure secure communication of the PIN code to the personal security device CP. According to the invention, the intermediate module M1 also serves as a gateway for communication between and secure personal module CP and the escrow module MTC.

The intermediate module M1 is a software and/or hardware module which is activated no later than just before the need for access to the protected resource of the personal security device CP and generally just after the introduction of the smart card CP into the reader.

According to the invention, the intermediate module M1 obtains at least a secure session key, required for secure transmission of the PIN code to the personal security device CP, to an escrow module MTC which, according to the illustrated example, is remote and communicates with the intermediate module M1 via the Internet telecommunications network.

According to a preferred but not exclusive form of implementation of the procedure according to the invention, access protected by PIN code to the protected resource of the personal security device CP runs according to the following sequence more specifically shown in FIG. 2.

Firstly, there shall be an authentication of the smart card CP by the escrow module MTC. Indeed, we must ensure the presence of a genuine smart card to prevent the use of a “bait” smart card triggering the implementation of the procedure according to the invention and then its analysis. The authentication sequence of the smart card corresponds with steps 1 to 13 of FIG. 2 as will appear later.

According to the illustrated example, the escrow module MTC comprises, on one hand, a knowledge control module MCC and, on the other hand, a secure session key generating module MGC. In the present case, the knowledge control module MCC and secure session key generation module MGC are implemented on two separate servers, respectively SV1 and SV2, and, preferably, each located at least partially in a security hardware module of the corresponding server. Servers SV1 and SV2 are of course suited for handling simultaneous requests from different intermediate modules M1 activated on various local units UL connected to the Internet.

The knowledge control module MCC provides a management function of direct communications with each intermediate module M1 and relay of communications to the secure session key management module MGC. Thus, each intermediate module M1 communicates with a secure session key management module MGC only through the knowledge control module MCC acting as a proxy server. Communications between the secure session key management module MGC and the knowledge control module will preferably be made through a secure connection with mutual authentication.

The session management module of the secured session keys MGC also provides an authentication function of the smart card CP as reflected in the following.

According to the illustrated example, the smart card CP is authenticated through a mutual authentication of the smart card CP and escrow module MTC resulting from the establishment of a secure communication channel between the smart card CP and escrow module MTC and especially its secure session key generation module MGC. This communication channel will be established, through the intermediate module M1 and the knowledge control module MCC of the escrow module MTC, with strong authentication using a challenge-response type procedure in the framework of the of a “augmented PAKE” type protocol as for example those meeting the standard IEEE P1363.2.

To strengthen the resistance of the procedure according to the invention against man-in-the-middle type attacks, communications between the intermediate module mi and the escrow module MTC are preferably but not necessarily secure. This secure link is preferably established with an authentication of the escrow module MTC by a certificate issued under a public key infrastructure (PKI). Among the protocols liable to be used for the establishment of such a connection between the intermediate module M1 and the escrow module MTC and, more specifically here, the knowledge control module MCC, it is possible to cite the TLS protocol for Transport Layer Security, formerly known as SSL (Secure Sockets Layer).

After introducing the smart card CP in the reader LC and initiation of the process of access to a secured resource of the smart card CP, the smart card CP is authenticated through the implementation of a secure link with mutual authentication between the smart card CP and escrow module MTC, and here, its knowledge control module. In the case of the implementation of a smart card to standards ISo7816 and ISO 7816-4, mutual authentication result for example of the setting up of a secure connection using the methods for secure messaging features. In the case of a smart card of IAS type whose protocol and operation is specified by the GIXEL (FRENCH GROUP OF INDUSTRIES OF COMPONENTS AND ELECTRONIC SYSTEMS) it is possible to refer to the V1.01 and IAS ECC specification document and particularly in its chapter 5.2.2.2.2 titled Steps of authentication.

Thus, the intermediate module M1, in a step 1, sends a request to challenge the smart card CP which, in a step 2, sends a challenge. Such a challenge is for example a random number RND.CP, in 8 bytes, generated by the smart card CP.

In a step 3, the intermediate module M1 relays this challenge to the knowledge control module MCC, by associating the ID.CP identification of the smart card CP. The knowledge control module MCC sends, in a step 4, the RND.CP challenge request for and the PIN identification of the smart card CP to the secure session key generation module MGC.

The secure session key generation module MGC comprises the secrets needed to generate session keys that are compatible with each of the smart cards managed by the escrow module MTC. The secure session key generation module comprises among others the master keys for recalculating the secret key associated with each of the smart cards CP. The secure session key generation module MGC calculates, from the identification ID.CP of the smart card, the secret key SK.CP of the latter to generate a response to the challenge a step 5 from this secret key.

The answer is for example formed as follows:
the key generation module MGC generates a random 8-byte number RND.MGC,
the key generation module MGC generates a random session key K.MGC,
the key generation module MGC concatenates an S chain comprising:
   the random number RND.MGC,
   the identifier of the module ID.MGC,
   the challenge request RND.CP,
   the identifier of the ID.CP smart card,
   the random session key K.MGC.
the key generation module MGC computes a DATA value by encrypting the S chain by means of the SK.CP secret key
the key generation module MGC calculates a MAC value from DATA by using the secret key SK.CP according to an HMAC algorithm for the Hash-based Message Authentication Code as defined by document RFC2104. Among the algorithms liable to be used, it is possible to mention SHA1 or SHA256.

In a step 6, the response to the challenge, consisting of DATA and MAC, is sent to the knowledge control module MCC which sends it in a step 7 to the intermediate module M1. In a step 8, the said intermediate module M1 sends the response to the challenge to the smart card CP.

In a step 9, the smart card CP then calculates, from the response to the challenge, on the one hand, a shared secret and, on the other hand, a response to the shared secret. The smart card CP also computes encryption and integrity session keys from the shared secret. To do this, the smart card CP does the following operations:
the smart card CP checks the integrity of the DATA value through the MAC value and its secret key SK.CP
the smart card CP decrypts the DATA value using its secret key SK.CP to obtain the data: RND.MGC; ID.MGC; RND.CP; ID.CP; K.MGC.
the smart card verifies that the values RND.CP; ID.CP correspond with the values it sent.

If verification is positive the following sequence is implemented:
the smart card CP records the value K.MGC,
the smart card CP generates and records a random session key K.CP,
the smart card CP concatenates an S′ chain comprising:
   the random number RND.MGC,
   the identifier of the module ID.MGC,
   the challenge request RND.CP,
   the identifier of the ID.CP smart card,
   the random session key K.CP.
the smart card CP computes a DATA′ value by encrypting the S′ chain by means of the SK.CP secret key.
the smart card CP computes a MAC′ from DATA′ by using the SK.CP secret key in the framework of the HMAC algorithm used by the module MGC.

The answer of the shared secret is then formed by DATA′ and MAC'.

In a step 10, the smart card CP sends the response of the shared secret to the intermediate module M1 that sends it on in a step 11 to the knowledge control module MCC, which relays it to the secure key management module MGC in a step 12.

In a step 13, the secure key session management module MGC verifies the answer from the shared secret. To do this, the following operations are implemented:
the secure key session management module MGC checks the integrity of the DATA′ value from the MAC′ value,
the secure key session management module MGC decrypts the DATA′ value using the secret key SK.CP to obtain the data: RND.MGC; ID.MGC; RND.CP; ID.CP; K.CP.
the secure key session management module MGC that the values RND.MGC; ID.MGC correspond with the values it has issued.

In case of positive verification, the secure session key module management MGC records the random session key K.CP emitted by the smart card CP and concludes the authentication of the smart card CP. In a step 14 the secure session key management module MGC transmits a positive message of authentication of the smart card to the knowledge control module MCC. This message is then relayed, in a step 15, by the knowledge control module MCC to the intermediate module M1.

Following receipt of the positive authentication message, the intermediate module M1 requires, in a step 16, an input by the user U of the PIN code. Of course, if a message other than a positive identification is received, the intermediate module M1 does nothing. In a step 17, the user U enters the PIN code. This entering can be done via the local unit keypad C. However, to avoid the risk of leaks by ASCII codes sent by the keypad to the local unit being listened to, the intermediate module M1 displays a virtual keypad CV on the screen E that can be numeric or alphanumeric and on which the user chooses the character of his PIN code by using the mouse S. The intermediate module M1 can then be adapted so as not to be able to receive the code from the keypad C so as to neutralize the use for entering the PIN code.

Once the PIN code is entered, the intermediate module M1 will seek information needed to communicate in a secure form of the PIN code to the smart card from the escrow module MTC.

To do this, a secure communication channel is established according to a zero-knowledge protocol between the intermediate module M1 and the escrow module MTC.

To begin the process of obtaining at least one secure session key, in a step 18, the intermediate module M1 sends proof of knowledge P of the PIN code in the framework of the zero-knowledge protocol to the escrow module MTC which will process by the knowledge control module MCC. The proof P sent is for example an element calculated from the PIN code. The algorithm for calculating this proof element is designed so as not to allow discovery of the PIN code by inverse calculation. Moreover, to give a non-replayable or single use to the proof of knowledge, it is preferably associated with two random numbers, one generated by the intermediate module M1 and the other by the knowledge control module MCC. These random numbers can be exchanged in step 18, then comprising a return journey needed for that before sending proof of possession. In an optimization of the process, the exchange of these random numbers can also be integrated in steps 11 and 15.

In a step 19, the knowledge control module MCC checks the validity of the proof of knowledge. For this purpose, the knowledge control module MCC comprises a record of the PIN code or verifying element to ensure that proof of knowledge is correct without knowing the PIN code himself. In a preferred form of the invention, the knowledge control module will not comprise a record of the PIN code.

If the proof of knowledge is valid, the escrow module and, more particularly, its knowledge control module MCC sends a message of positive verification, in a step 20, to the intermediate module M1.

This positive verification message preferably takes the form of a message comprising an encrypted secret value that the knowledge control module MCC has been able to calculate only if it possessed the verification elements of the proof of possession sent by the intermediate module M1. It also has authentication value of the knowledge control module MCC by the intermediate module M1. Once decrypted, the secret value that is now shared between the two modules can be used as a shared secret key to encrypt future items exchanged between them if necessary. Operations, which have just been described can be implemented according to the SRP-SHA1 protocol described in documentation RFC2945, which is the most commonly used Augmented-PAKE protocol type. Moreover, going from an implementation on the basis of SRP-SHA1, the skilled person knows how to substitute SHA256 algorithm for the SHA1 algorithm or other similar algorithm to obtain a higher level of security.

In order to avoid an external analysis of the operating mode of the escrow module MTC, it is preferably set to send a control message in return for each sending of proof of knowledge regardless of the result of the check. In the same vein, this control message is sent within a time independent from the verification results.

In a step 21, the knowledge control module MCC sends a request for export of the session keys to the secure session key generation module MGC. The secure session key generation module MGC calculates, in a step 22, the SKENC encryption session and SKMAC integrity keys from random session keys K.CP and K.MGC generated in the framework of the authentication of the smart card PC. A method for generating SKENC and SKMAC session keys is particularly described in chapter 7.14 of the Specification IAS ECC V1.01 mentioned above.

In a step 22, the secure session key generating module sends the SKENC encryption and SKMAC integrity session keys to the knowledge control module MCC which will send them in a step 23 to the intermediate module M1. In a preferred form of the invention, the knowledge control module MCC uses the secret key shared with the intermediate module M1 to encrypt the session keys, and ensure in all cases that a man-in-the-middle type intermediate cannot read the session keys.

The intermediate module M1 then uses the SKENC encryption key to encrypt the PIN code in a secure form and formats a message to the smart card CP by means of the SKMAC integrity session key. In step 24, the intermediate module sends this formatted message to the smart card.

Insofar as the various exchanges of steps 2 to 15 and 18 to 24 were not corrupted, the smart card CP may, from SKENC encryption and SKMAC integrity keys, verify the integrity of the message received from the intermediate module M1 and decrypt the PIN code.

The smart card CP can then check the identifier code and, if the check is positive, activate the protected resource associated with the PIN code and/or allow access to this protected resource.

It therefore appears that the procedure according to the invention fights to the maximum against malicious appropriation of the PIN code.

It should be noted that insofar as the SKENC and SKMAC secure session keys are generated from the random K.CP and K.MGC session keys for the time of the current session, the SKENC and SKMAC secure session keys are not repeatable and can be transmitted to the knowledge control module MCC and the intermediate module M1 without risk for the permanent secrets of the smart card CP. Similarly, it is not strictly necessary to implement two separate keys for encryption and integrity checking. Indeed a single key can be used to provide encryption and integrity checking. The single-key encryption algorithm can also be implemented, which guarantees the integrity of encrypted data such as the AES-GCM algorithm.

To further strengthen the security of the system, the escrow module MTC can be adapted to keep track of the different connections associated with each smart card CP. To this end, the knowledge control module may comprise or be associated with a fraud detection module MDF adapted to record the number of connections associated with each smart card CP and the knowledge control result of the PIN code for each connection. The fraud detection module MDF will be used to allow or disallow a new connection for a smart card depending on the recorded values. In this regard, the fraud detection module MDF can be adapted to prevent or to control the MCC module to prohibit any new connections from a given number of connections associated with the transmission of a wrong PIN code.

The fraud detection module MDF can also be adapted to implement security rules to identify large numbers of requests issued by automated systems or requests in too high a number than would correspond with normal use of the personal security device or smart card CP.

Furthermore, the method of generating shared secure session keys described above is only one possible form of implementing the invention and it is possible to implement other methods known to people of the trade to establish a non-replayable shared session key from a shared secret held by the smart card CP and the escrow module MTC. Among these methods it is possible to mention the Diffie-Helman algorithm.

Obviously, various other modifications may be made to the invention in the framework of the appended claims

1. Method of accessing via a PIN code associated with a user at least one protected resource of a personal security device communicating with a local unit controlled by the user, the method comprising the following steps:
implementation by the local unit of an intermediate module for PIN code entry,
authentication, via the intermediate module, of the personal security device by an escrow module,
in case of a positive authentication of the personal security device by the escrow module:
request, by the intermediate module, for the PIN code to be entered by the user (U),
obtaining by the intermediate module from the escrow module of at least one secure session key, said step of obtaining at least one secure session key comprising:
sending by the intermediate module to the escrow module of proof of knowledge of the PIN code different from the PIN code and for single use,
in case of recognition, by the escrow module, of the validity of the proof of knowledge of the PIN code, generation, at least by the escrow module, of at least one secure session key by means of secret information associated with the personal security device,
sending each at least one secure session key to the intermediate module,
sending to the personal security device, by the intermediate module, of the PIN code in a secured form by means of each at least one secure session key.

2. Method according to claim 1, wherein the intermediate module communicates with an escrow party module through a secure connection.

3. Method according to claim 1 wherein the authentication of the personal security device is made in the framework of a mutual authentication of the personal security device and the escrow module according to a cryptographic challenge-response type challenge protocol.

4. Method according to claim 1, wherein the proof of knowledge is transmitted using a zero-knowledge type protocol.

5. Method according to claim 1 wherein the escrow module comprises a knowledge control module for verifying the knowledge of the PIN code and a secure session key generating module.

6. Method according to claim 5, wherein the knowledge control module communicates with the secure session key generation module via a secure mutual authentication connection.

7. Method according to claim 5, wherein the intermediate module communicates only with the knowledge control module from the escrow module.

8. Method according to claim 5, wherein the escrow module is at least partially integrated in a hardware security module.

9. Method according to claim 5 wherein the secure session key generation module and/or the knowledge control module is integrated in a hardware security module.

10. Method according to claim 8, wherein the knowledge control module and the secure session key generation module are each integrated in two separate servers.

11. Method according to claim 1, wherein the PIN code is entered through a GUI displaying a virtual keypad on a screen of the local unit and a pointing interface allowing the user to select characters on the virtual keypad.

12. A computing device comprising means for communication with a personal security device, man-machine interface means and means of communication with an escrow module, wherein the computer device comprises an intermediate module adapted to implement the access method according to claim 1.
